(19) United States
(12) Patent Application Publication
(10) Pub. No.: US 2011/0038565 A1
(43) Pub. Date: Feb. 17, 2011

(54) MEANS FOR CLOSING A BAG HAVING A DEGRADABLE, BIODEGRADABLE AND/OR COMPOSTABLE COATING

(75) Inventors: André Grob, Singapore (SG); Peter Poelman, Velzeke (BE); Alain Leplae, Moorsele (BE)

Correspondence Address: FOLEY AND LARDNER LLP;SUITE 500, 3000 K STREET NW, WASHINGTON, DC, 20007, US

(73) Assignee: NV BEKAERT SA, Zwevegem (BE)

(21) Appl. No.: 12/988,569

(22) PCT Filed: Apr. 20, 2009
(86) PCT No.: PCT/EP09/02859

§ 371 Date: Oct. 19, 2010

(30) Foreign Application Priority Data
Apr. 21, 2008 (EP) 08154845.5

(51) Int. Cl. B65D 33/16; B31B 1/90

(52) U.S. Cl. 383/71; 493/214

(57) ABSTRACT

The application relates to a means for closing a bag, in particular a bag made of bio plastics. The means for closing a bag comprises at least one wire covered at least partially with a coating of a bio plastics. The coating is a closed coating offering the wire corrosion protection when exposed at normal ambient conditions during storage or use of the means and the coating being degradable, biodegradable or compostable once the means is exposed to an environment suitable for decomposition.

### TECHNICAL FIELD

The invention relates to the use of a means for closing a bag. The means comprises at least one wire covered with a coating of a bio plastics. The invention further relates to a bag, preferably a bag made of a bio plastics, closed with a means for closing for closing a bag. The invention further relates to a method for decomposing said wire and/or said plastic bag.

### BACKGROUND ART

Bio plastics are a form of plastics derived from renewable biomass sources such as vegetable oil or starch such as corn starch. Because of their biological biodegradability, the use of bio plastics is especially popular for disposable items such as packaging material. Bags such as shopping bags or refuse bags made of biodegradable materials are known in the art. After their initial use they can be composted.

For many applications it is required that the bags are closed or sealed. Generally this is done by using a plastic coated metal wire or clip, often called a twist tie. The metal wire of such a plastic coated wire or clip provides the required strength whereas the plastic coating provides the required corrosion protection. Steel wires provided with an extruded polymer coating, such as polyvinylchloride or polyester, are generally known in the art.

Disposal after use creates a waste problem. Most polymer coatings, such as polyvinylchloride and polyester, are not or not fully degradable and burning leads to toxic materials. Normally, the steel wire would rust away, but the plastic coating prevents this. If the wire is thrown away as such, decomposition of polymer and steel wire takes a very long time resulting in a lot of long lasting and toxic waste, and a risk to the local environment.

Another problem arises when hazardous material, such as polymer coatings, need to be separated from the steel wire, e.g. before combustion or when recycling. This is a tedious job which is hardly ever applied. This is also not commercially or economically feasible.

Plastic coatings made of bio plastics exhibit the drawback of being stiff and brittle and they cannot be used for applications where resilient and softness properties are required. Therefore, bio plastics are often mixed with other polymers or plasticizers that enhance the elasticity properties, hereby however also decreasing the biodegradability and/or compostability.

Wires used to close bags require specific elasticity properties to be able to withstand the torsions of the wire.

Therefore there is a need for wires for closing bags having the same resilient properties as conventional polymers, that can be safely, easily and cheaply disposed of after use.

### DISCLOSURE OF INVENTION

It is an object of the invention to provide a means for closing a bag comprising a wire and a coating, whereby the coating has the same resilient properties as the conventional polymers, but which can be disposed of with low or even no problem.

It is a further object of the invention to provide means for closing a bag that are degradable and/or biodegradable and/or compostable.

It is another object of the present invention to provide means for closing a bag that combine the features of having a good corrosion protection during their storage and use and being degradable and/or biodegradable and/or compostable once placed in an environment to decompose.

Plastic coated wires or clips are a popular binding means to close or seal a bag. Such wires or clips are for example made of one or more wires covered by a polymer coating. The wire or wires provide strength, whereas the coating prevents the steel wire core from rusting. Wires used for this binding means requires a high flexibility as the means need to be twisted and untwisted many times into many different configurations without breakage.

In a first embodiment the invention provides the use of a means for closing a bag. The means comprises at least one wire covered at least partially with a coating of a bio plastics. The coating is preferably a closed coating offering the wire or wires a good corrosion protection when exposed at normal ambient conditions during storage or use of said means and the coating is degradable, biodegradable or compostable once this means is exposed to an environment suitable for decomposition. This implies that the means according to the present invention combines the features of having a good corrosion protection during its storage and during its use for closing a bag and that the means is degradable, biodegradable or compostable once the means is placed in a environment suitable for decomposition.

The coating must be such that no degradation at normal ambient conditions for a wire or for a clip can be observed. In addition when exposed at normal ambient conditions the coating offers the wire a good corrosion protection. To test the corrosion resistance of the wire, the wire is exposed to an environment at a temperature of 40° C. and relative humidity of 100%. After 500 hours exposure no white rust or dark brown rust could be observed.

The corrosion protection of the wire according to the present invention during storage and use of the wire for closing a bag is obtained as the coating forms a closed coating.

With “closed” coating is meant a coating that is covering the wire fully, i.e. a coating that is covering the wire 100% or substantially 100%. For a person skilled in the art it is clear that some defects can be present in the coating.

Normal ambient conditions for a means for closing a bag are the environmental conditions such as pressure, temperature, relative humidity that are normal for a given location.

Once brought in an environment suitable for decomposition of the coating, holes are formed in the coating allowing said environment to form rust on the steel through said holes till after a certain period in time the coating will be completely decomposed.

An “environment suitable for decomposition of the coating” according to the present invention is any environment other than an ambient environment. This may be e.g. damp environment, a compost heap or a burning oven. Decomposition may be established in e.g. 75 days.

The means for closing a bag comprises at least one wire. Possibly the means for closing a bag comprises a number of wires, for example a number of wires located parallel to each other in a plane. The number of wires is preferably ranging between 1 and 10, as for example 1, 2 or 3.

In principle any flexible wire can be used. Preferaby, the wire is a steel wire, more preferably a low carbon steel wire. The carbon content is preferably lower than 0.35 wt %, for example ranging between 0.01 wt % and 0.20 wt %. The complete composition of the wire may be as follows : a carbon content of 0.06 wt %, a silicon content of 0.166 wt %, a chromium content of 0.042 wt %, a copper content of 0.173 wt %, a manganese content of 0.382 wt %, a molybdenum content of 0.013 wt %, a nitrogen content of 0.006 wt %, a nickel content of 0.077 wt %, a phosphorus content of 0.007 wt %, a sulfur content of 0.013 wt %.

The diameter of the wire or wires is preferably ranging between 0.30 and 4 mm, for example ranging between 0.60 and 1.60 mm. The steel wire is highly mechanically deformed. In a specific embodiment, the mechanically deformed steel wire forms is twisted to close a bag

In one embodiment the wire(s) such as the steel wire(s) is/are covered with an intermediate metallic coating. In one embodiment said metallic coating is a copper, copper alloy, zinc, zinc alloy, nickel, nickel alloy, tin or tin alloy.

The coating comprises bio plastics. Bio plastics have great ecological advantages: they are derived from renewable sources and decompose by microorganisms without leaving any residue or giving rise to toxic byproducts. The same amount of carbon dioxide that is given off when incinerated or decomposed, is absorbed from the atmosphere by the raw product. There is no increase of carbon dioxide, and thus no greenhouse gas emissions. Moreover, the cost of bio plastics is such that it has become competitive for use in many applications.

The term “bio plastics” covers a new generation of biodegradable and/or compostable plastics derived from renewable raw materials such as starch (e.g. corn, potato, tapioca), cellulose, soy protein, lactic acid or any other. Bio plastics are not hazardous in production and decompose back in the environment when discarded into carbon dioxide, water and biomass.

Corn starch is currently the main raw material being used in the manufacture of bioplastic resins. Mater-Biand PolyActide (PLA), both made from corn-starch, are currently the two main resins (raw materials) being used today in the production of compostable and biodegradable plastics and are certified for compostability under standards set by international organizations. The field of bio plastics is constantly evolving with new materials and technologies being worked on and being brought to market. In one embodiment the present invention relates to the use of any of such bio plastics in coatings for wires or clips to close bags.

In one particular embodiment said bio plastics material is a biodegradable material.

In another embodiment said bio plastics material is a compostable material.

In yet another embodiment of the present invention said bio plastics material coating a steel wire is a degradable material.

The term “biodegradable material” is material which will degrade from the action of naturally occurring microorganism, such as bacteria, fungi etc. over a period of time. There is no requirement for leaving no toxic residue, and no requirement for the time it needs to take to biodegrade. A biodegradable material has the ability to break down, safely and relatively quickly, by biological means, into the raw materials of nature and disappear into the environment. These products can be solids biodegrading into the soil (which we also refer to as compostable) or liquids biodegrading into water. Biodegradable material is intended to break up when exposed to (naturally occurring) microorganisms such as bacteria, fungi etc. over a period of time.

The term “compostable material” is material which is capable of undergoing biological decomposition in a compost sit, such that the plastic is not visually distinguishable and breaks down to carbon dioxide, water, inorganic compounds, and biomass, at a rate consistent with known compostable materials (e.g. cellulose), and leaves no toxic residue (American Society for Testing & Materials (ASTM)).

In order for a material to be called compostable, three criteria need to be met:

a) biodegrade or break down into carbon dioxide, water, biomass at the same rate as cellulose (paper);

b) disintegrate so that the material is indistinguishable in the compost; and

c) eco-toxicity meaning that the biodegradation does not produce any toxic material and the compost can support plant growth.

“Degradable material” is material which will undergo a significant change in its chemical structure under specific environmental conditions resulting in a loss of some properties.

Viewed from a particular point of view, an embodiment of the bio plastics material is degradable, biodegradable or compostable for at least 75%, preferably at least 80%, more preferably at least 85%, yet more preferably at least 90%. In a preferable embodiment the coating is 95% degradable, biodegradableor compostable or degradable. The polymer coating may e.g. comprise 95% bio plastics and 5% other polymer enhancing other characteristics like distortion or elongation.

In a most preferred embodiment said bio plastics coating is 100% degradable, biodegradable or compostable.

In one embodiment said coating comprises polylactide acid (PLA).

In yet another embodiment said coating comprises a composition of bio plastics and conventional polymers.

In a specific embodiment said coating comprises a mix or composition of different bio plastics. One bio plastics material may have more favourable features, such as e.g. elasticity, while the other may be more compostable.

In yet another embodiment said coating of bio plastics further comprises a color masterbatch.

In another embodiment said coating may be mixed with plasticizers, dyes and/or lubricants.

In one embodiment said coating has an elongation of at least 4%, preferably 8%.

The thickness of the coating may determine the decomposing rate or environment: the thicker the coating, the longer it takes to decompose.

Once the means for closing a bags is no longer needed, it can be subjected to burning or decomposition in a suitable medium. The degradable, biodegradable or compostable coating will burn without being toxic, or will decompose naturally over time, and the core wire will rust away.

Although steel wire covered with a degradable, biodegradable or compostable coating is protected from rust, the degradable, biodegradable or compostable coating will decompose with the passage of time. This is accomplished for example by a damp environment, e.g. damp soil or a compost heap, wherein the coating is decomposed by microorganisms, without leaving any residue or toxic byproducts. A hole will open up partly, hereby exposing the steel wire to water and condense allowing the formation of rust. As time passes further on, decomposition of the degradable, biodegradable or compostable coating continues as does the rusting of the steel wire. Finally the degradable, biodegradable or compostable coating and the steel wire decomposes and disappears.

According to a second aspect of the present invention a bag closed or sealed by a means for closing a bag as described above is provided.

As bags any packaging made of a thin flexible film such as a plastic film or a bio plastics film can be considered. Bags are for example used for containing and transporting food, waste, gardening products etc. Bags can be made with a variety of plastic films. Polyethylene, of various grades and types, is the most common. Other forms, including laminates and coextrusions can be used when the physical properties are needed. Several types of bags can be considered such as plastic shopping bags, i.e. open bags with carrying handles often provided by stores as a convenience to shoppers, trash bags, flexible intermediate bulk containers (large industrial containers usually used for powders or flowables).

The invention is in particular suitable to close bags made of bio plastics. After their initial use these bags can be reused as bags for organic for organic waste and then be composted. When these bags are closed with a wire to close a bag known in the art, i.e. a wire covered with a plastic coating although the bag as such as degradable, biodegradable or compostable, the wire to close the bag is not. A wire according to the present invention on the other hand is degradable, biodegradable or compostable and it is clear that a wire according to the present invention is of particular importance to be used for this type of bags.

Furthermore, a wire according to the present invention is very suitable to close bags comprising gardening products. In particular if also the bag to hold the gardening products is made of bio plastics.

Preferably the bag is made of a material that is degradable, biodegradable or compostable for at least 75%, preferably at least 80%, more preferably at least 85%, yet more preferably at least 90%, most preferably at least 95%.

In a preferred embodiment the bag according to the present invention is made of a material that is 100% degradable, biodegradable or compostable.

According to a third aspect of the present invention, a method for environmentally safe decomposing a bag—optionally with its content—closed by a means for closing bag as described above is provided. The method comprises the steps of
a. placing the bag including the means for closing the bag in an environment suitable for decomposition of the bag and the means for closing the bag in order to form holes in said coating,
b. allowing said environment to form rust on the wire such as the steel steel through said holes, and
c. waiting until the coating and the wire, such as the steel wire have completely decomposed.

An “environment suitable for decomposition of the coating” according to the present invention is any environment other than an ambient environment. This may be e.g. damp environment, a compost heap or a burning oven. Decomposition may be established in e.g. 75 days.

### BRIEF DESCRIPTION OF FIGURES IN THE DRAWINGS

FIG. 1 and FIG. 2 show cross-sections of two embodiments of a means for closing a bag according to the present invention.

FIG. 3 shows a sheet comprising a number of means for closing a bag located parallel in one plane.

FIG. 4 shows a first embodiment of a bag closed with a means for closing a bag according to the present invention.

FIG. 5 shows a second embodiment of a bag closed with a means for closing a bag according to the present invention.

### MODE(S) FOR CARRYING OUT THE INVENTION

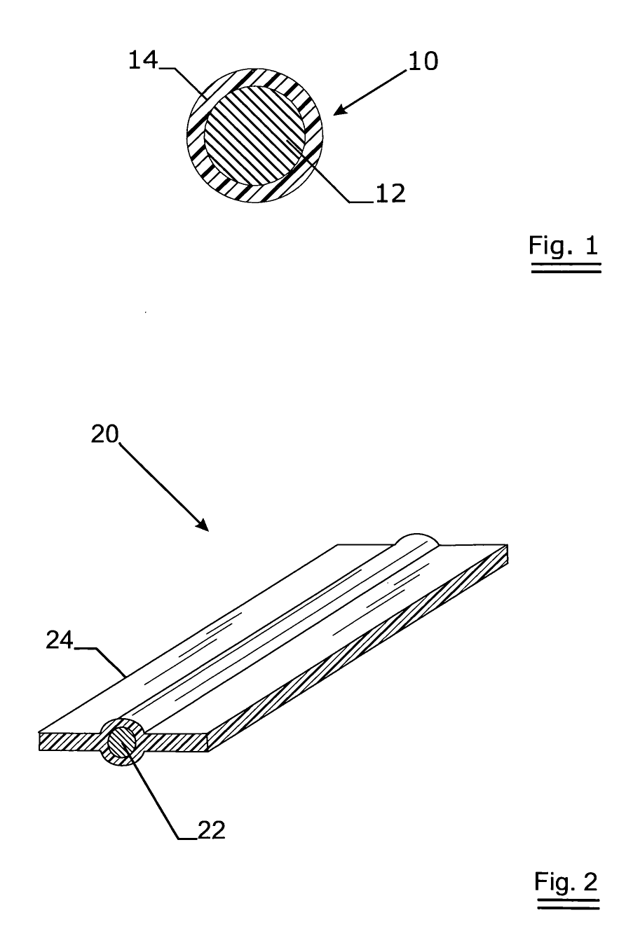

FIG. 1 shows a cross-section of a means 10 for closing a bag according to the present invention. The means 10 comprises a steel wire core 12 covered with a bio plastics coating 14. The diameter of the steel core ranges from 0.30 to 4. The thickness of the coating ranges from 0.020 mm to 0.30 mm.

FIG. 2 shows a cross-section of an alternative means 20 for closing a bag. The means 20 comprises a steel wire 22 covered by a bio plastics material 24. The bio plastics material 24 can be applied as coating on the wire or alternatively by a bio plastics film or a pair of bio plastics films.

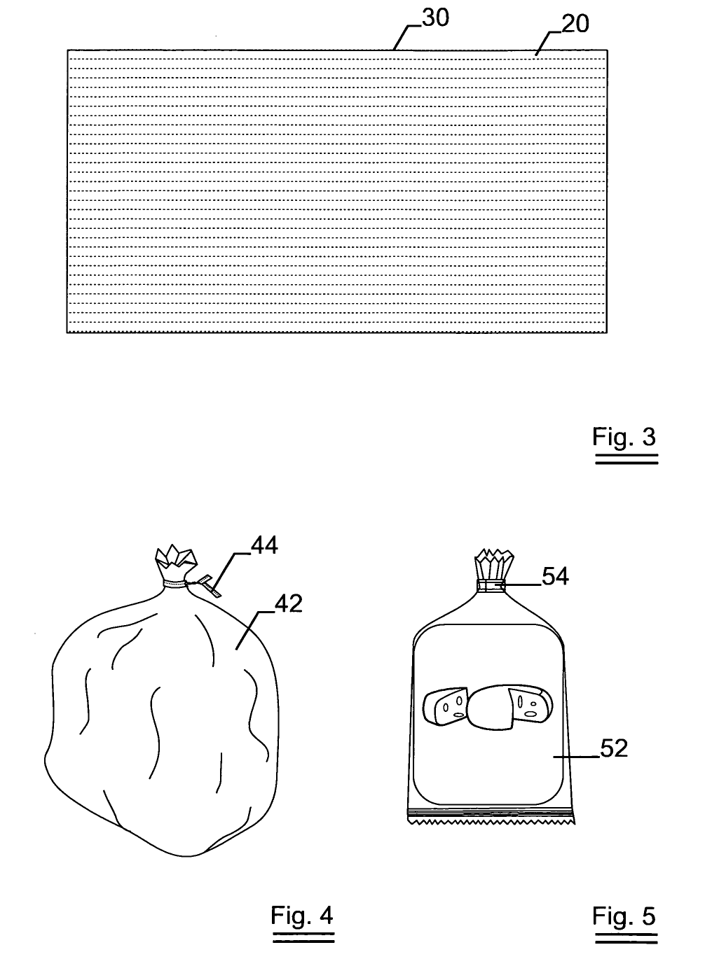

FIG. 3 shows a sheet 30 of monoaxially orientated means 20 for closing a bag as shown in FIG. 2. Tear off lines allow that a means 20 for closing a bag can be tore off.

FIG. 4 shows a bag 42 closed with a means 44 for closing a bag according to the present invention. The ends of means 44 are twisted to close the bag 42.

FIG. 5 shows a bag 52 closed with a means 54 for closing a bag according to the present invention.

### EXAMPLE 1

### Wire Coated with PLA and Color Masterbatch

A wire was coated with the biodegradable polymer polyactide acid (PLA) (PLA 2002D from NatureWorks®). PLA is derived from naturally-occurring plant sugar (corn starch). PLA has a glass transition temperature of between 55 and 65° C. and a density of 1,25 g/cm³. Besides the advantages listed above, PLA also has a very low degree of toxicity. Furthermore, PLA is excellent for printing on and has great tensile strength, meaning that the coating thickness can be reduced. These are advantageous characteristics for use in the paper industry.

It is common practice to provide wires with different colors to provide an additional coding or just for the aesthetic aspect. For this purpose, color master batches are available in a wide variety of transparent and opaque colors, for use with starch-blend biopolymers, polylactic acid (PLA), copolyesters and other biodegradable, compostable or degradable resins. Examples of providers are SUKANO® and PolyOne Corp®. Color masterbatches may specifically be added for enhancing properties like denesting, antistatic, slip, anti-block, ultraviolet barrier, blue tone and anti-fog types.

It has now been found surprisingly that adding a color masterbatch to pure PLA greatly improves the mechanical properties of PLA coated wire for use in wire or clips for closing bags. As such, these polymers are less brittle and stiff and very suitable for coating wires according to the present invention.

Table 1 lists some test results. Pure PLA (natural 2002D) has an elongation of 4%, which may as such be sufficient to be applied without cracks on wires to closed bags that are twisted in thin coatings. After addition of 2% Bio-RED (color masterbatch) the properties of the coating were strongly enhanced, up to an elongation of 8%.

TABLE 1

| Coating | Elongation |
|---|---|
| PLA natural 2002D | 4.46% |
| PLA + 2% Bio-RED | 8.09% |

Other PLA Masterbatches are e.g. Bio-White, Bio-Black, Bio-Green and Bio-Blue.

The bio plastics coated steel wires of the present invention may also be used in other applications.

A biodegradable coating such as PLA can be applied to the steel wire using the conventional extrusion process.

A biodegradable coating such as PLA gives a good adhesion to the steel wire without the necessity of applying particular adhesives or primers.

The adhesion between the thermoplastic material such as PLA and the steel wire can be evaluated by carrying out the following test. The PLA coating is removed in the longitudinal direction over about 5 cm by means of the sharp side of a knife. By means of the blunt side of the knife the PLA coating is slightly lifted. Finally, the PLA coating is tried to be pulled off the metal member with the fingers. The more difficult the PLA coating can be pulled off, the stronger the adhesion of the PLA to the steel wire. Tests with PLA coating have resulted in an adhesion level of 1 to 2 on a scale of 5.

1. Use of a means for closing a bag, said means comprising at least one wire covered at least partially with a coating of a bio plastics, said coating being a closed coating offering said wire corrosion protection when exposed at normal ambient conditions during storage or use of said means and said coating being degradable, biodegradable or compostable once said means is exposed to an environment suitable for decomposition.

2. Use according to claim 1, wherein no white rust and no dark brown rust is observed on said wire when exposed during 500 hours to an environment of 40° C. and a relative humidity of 100%.

3. Use according to claim 1, wherein said wire is a metal wire.

4. Use according to claim 1, wherein said coating is degradable, biodegradable or compostable for at least 75%, preferably at least 80%, more preferably at least 85%, yet more preferably at least 90%, most preferably at least 95%.

5. Use according to claim 1, wherein said means is degradable, biodegradable or compostable for at least 75%, preferably at least 80%, more preferably at least 85%, yet more preferably at least 90%, most preferably at least 95%.

6. Use according to claim 1, wherein said coating is 100% degradable, biodegradable or compostable.

7. Use according to any one of the preceding claims claim 1, wherein said coating comprises polylactide acid (PLA).

8. Use according to claim 1, wherein said wire is covered with an intermediate metallic coating.

9. Use according to claim 8, wherein said intermediate metallic coating is a copper, copper alloy, zinc, zinc alloy, nickel, nickel alloy, tin or tin alloy.

10. Use according to claim 1, wherein the metal wire is a low carbon steel wire with a carbon content below 0.35 wt %.

11. Use according to claim 1, wherein the wire is highly mechanically deformed.

12. A bag closed or sealed by a means for closing a bag, said means comprising at least one wire covered at least partially with a coating of a bio plastics, said coating being a closed coating offering said wire corrosion protection when exposed at normal ambient conditions during storage or use of said means and said coating being degradable, biodegradable or compostable once said means is exposed to an environment suitable for decomposition.

13. A method for environmentally safe decomposing a bag, optionally with its content, closed by a means for closing said bag, said means comprising at least one steel wire covered at least partially with a coating of a bio plastics, said coating being a closed coating offering said wire corrosion protection when exposed at normal ambient conditions during storage or use of said means and said coating being degradable, biodegradable or compostable once said means is exposed to an environment suitable for decomposition of said coating, said method comprising the steps of
a) placing said bag including said means in an environment suitable for decomposition of said bag and said means in order to form holes in said coating,
b) allowing said environment to form rust on the steel through said holes, and
c) waiting until the coating and the steel wire have completely decomposed.
